(19) United States
(12) Patent Application Publication
(10) Pub. No.: US 2026/0024996 A1
(43) Pub. Date: Jan. 22, 2026

(54) Supply network for an aircraft, associated aircraft and control process

(71) Applicant: DASSAULT AVIATION, PARIS (FR)

(72) Inventors: Alexandre AUROY, MERIGNAC CEDEX (FR); Thomas BARRACO, MERIGNAC CEDEX (FR); Zoé SIGRIST, MERIGNAC CEDEX (FR)

(21) Appl. No.: 19/276,377

(22) Filed: Jul. 22, 2025

(30) Foreign Application Priority Data
Jul. 22, 2024 (FR) FR 24 08043

(51) Int. Cl. H02J 3/12

(52) U.S. Cl. CPC H02J 3/12; B64D 2221/00; H02J 2310/44

(57) ABSTRACT

A power supply network for an aircraft, associated aircraft and control process, the network including a drive engine and an electric machine, the electric engine including a winding, the winding including at least three coils, the winding including a common midpoint for each coil. The network further including at least one converter, the or each converter being connected to the coils of the winding, loads connected to the or each converter, and an electronic control unit for the or each converter. The network also including connections of the midpoint of the or each winding to a ground power unit, and the electronic control unit is configured to control at least one converter in a voltage step-up operation.

### TECHNICAL FIELD

The present disclosure relates to a power supply network for an aircraft, the network comprising:
a drive engine;
an electric machine, mechanically connected to the engine for driving the electric machine, the electric machine comprising at least one winding, the or each winding comprising at least three coils, connected in a star configuration, the or each winding comprising a common midpoint for each coil;
at least one converter, the or each converter being connected to the coils of the or one of the windings of the electric machine;
loads connected to the or each converter; and
an electronic control unit for the or each converter, the electronic control unit being configured to control at least one converter from among the converter(s) in a voltage rectifier operation when the electric machine converts a mechanical torque provided by the engine into an alternating electric current.

### BACKGROUND

In order to recharge an onboard battery in an aircraft, it is known to recharge it using an external ground power source, also known in English as “Ground Power Unit,” when the aircraft is on the ground. However, in order to be able to use the ground power unit to charge the battery, it is necessary to use a converter, for example, a voltage step-up converter, connected between the battery and the external ground power source. In a known manner, a converter dedicated to charging the battery by the external ground power source is integrated into the aircraft, which increases the load and volume onboard the aircraft. Alternatively, it is also known to modify the external ground power source by connecting a ground converter to it, however, this limits the places where the aircraft battery can be recharged to locations with such a converter. Furthermore, this converter is often connected to the external ground power source with a specific connector, which further limits the possibility of charging the aircraft.

### SUMMARY

One aim of the present disclosure is therefore to propose a power supply network for an aircraft that allows the aircraft to be electrically powered with an unmodified external ground power source while limiting the load and volume onboard the aircraft.

To this end, the present disclosure has as its object, a network further comprising connections connecting the midpoint of each winding to a ground power unit,
the electronic control unit is configured to control at least one converter from among the converters in a voltage step-up operation when the connection is connected to a ground power unit for powering the midpoint of each winding, in order to electrically power the loads.

By means of the present disclosure, it is possible to electrically power the aircraft and, if necessary, recharge its battery without adding an additional converter to the network. Indeed, these existing systems in the aircraft for electrical power are used to step up the voltage to electrically power the aircraft from the ground power unit. Thus, it is not necessary to carry an additional converter dedicated to the electrical power of the aircraft when it is on the ground, which therefore limits the onboard mass.

Furthermore, it is also not necessary to modify the external power source used for charging by adding an additional converter. The aircraft can thus be powered by electricity from the ground by a standard auxiliary power unit, available at all airports or aeronautical bases.

According to other advantageous aspects of the present disclosure, the network comprises one or more of the following features, taken individually or in any technically possible combination:
the electric machine comprises a first and a second winding, and the network comprises a first and a second converter, the first converter being connected to the coils of the first winding and the second converter being connected to the coils of the second winding;
the network comprises a switch, and when the second converter is controlled in a voltage step-up operation, the midpoints of the first and second windings are connected to each other by the switch between the midpoints, and the connections connects a positive output terminal of the first converter to the ground power unit to power the midpoint of the second winding by means of the first converter and the first winding in order to electrically power the loads;
the electric machine comprises a first winding, and the network comprises:
   a second winding comprising at least three coils connected in a star configuration and a common midpoint for each coil,
   a first and a second converter, the first converter being connected to the coils of the first winding and the second converter being connected to the coils of the second winding, and
   a switch, connected between the midpoints of the first and second winding and in which, when the second converter is controlled in a voltage step-up operation, the midpoints of the first and second windings are connected to each other by the switch between the midpoints, and the connections connects a positive output terminal of the first converter to the ground power unit to power the midpoint of the second winding by means of the first converter and the first winding in order to electrically power the loads;
the network further comprises:
a second drive engine;
a second electric machine, mechanically connected to the second engine for driving the second electric machine, the second electric machine comprising a winding comprising at least three coils, connected to each other in a star configuration, so that the winding comprises a common midpoint for each coil;
a third converter, connected to the coils of the second electric machine and to the loads;
the connections are the first and second connections of the midpoint of each winding of the first electric machine to the ground power unit and the network comprises third connections of the midpoint of the winding of the second electric machine to the ground power unit;
the electronic control unit being configured to control the third converter in a voltage rectifier operation when the electric machine converts a mechanical torque provided by the second engine into an alternating electric current, and to control the third converter in a voltage step-up operation when the second connection is connected to the ground power unit for powering the midpoint of the winding of the second electric machine in order to electrically power the loads;
the or each winding comprises three coils and the or each converter comprises three branches, each branch comprising two switches, and a midpoint of each branch, located between the two switches, being connected to a coil of the winding;
the network comprises auxiliary connections of the or each converter to an external power source, and the electronic control unit is further configured to control the or each converter according to the voltage rectifier operation also when the auxiliary connection is connected to an auxiliary ground power unit, the auxiliary connections each comprising a switch, for powering the or each converter in order to electrically power the loads;
the loads include a battery, with a voltage greater than or equal to 250V, connected to the or each converter, and when the electronic control unit controls at least one converter from among the converters in a voltage step-up operation, the battery is electrically powered in order to be charged.

The present disclosure also relates to an aircraft comprising the previously described power supply network.

The present disclosure also relates to a control method for a power supply network, the power supply network being such as described above, the method comprising the following steps:
controlling at least one from among the converters in a voltage rectifier operation, when the electric machine converts a mechanical torque provided by the engine into alternating electric current; and
controlling at least one converter from among the converter(s) in a voltage step-up operation when at least one of the connections is connected to the ground power unit for powering the midpoint of the winding.

According to other advantageous aspects of the present disclosure, the method comprises the following features:
the method further comprises controlling at least one converter from among the converters in an inverter operation in order to electrically power the electric machine from a battery connected to the or each converter;
the network comprises auxiliary connections of the or each converter to an external power source, and the step of controlling the converter in the voltage rectifier operation is also carried out when the auxiliary connection is connected to the auxiliary ground power unit.

### BRIEF DESCRIPTION OF THE DRAWINGS

The present disclosure will become clearer upon reading the following description, given solely by way of non-limiting example, and made with reference to the drawings in which:

FIG. 1 is a diagram of an aircraft comprising a power supply network according to a first embodiment of the present disclosure;

FIG. 2 is a flowchart of a method according to one embodiment of the present disclosure;

FIG. 3 is a diagram of a power supply network according to a second embodiment of the present disclosure;

FIG. 4 is a diagram of a power supply network according to a third embodiment of the present disclosure;

FIG. 5 is a diagram of a power supply network according to a fourth embodiment of the present disclosure; and

FIGS. 6A and 6B are a diagram of a power supply network according to a fifth embodiment of the present disclosure.

### DETAILED DESCRIPTION

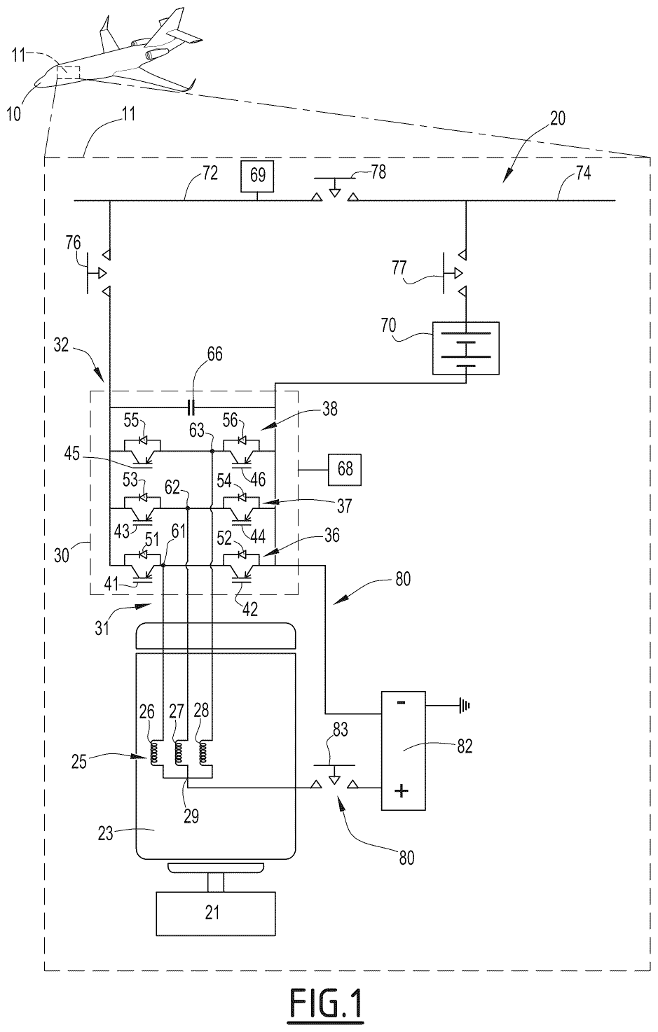

FIG. 1 represents an aircraft 10. The aircraft 10 is, for example, a plane or a drone. A detail 11 of the aircraft 10 is also represented in FIG. 1. The detail 11 shows a power supply network 20 included in the aircraft 10. The power supply network 20 comprises a thermal drive engine 21, mechanically connected to an electric machine 23 for driving the electric machine 23. The drive engine 21, also simply called engine, is an engine propelling the aircraft 10, especially when the aircraft 10 is in flight. The engine 21 is, for example, a turbojet.

The electric machine 23 is configured to convert a mechanical force, advantageously a mechanical torque received from the engine 21 into an electric current. Advantageously, the electric machine 23 is also configured inversely to convert an electric current into mechanical torque to drive the engine 21. The electric machine 23 is, for example, an electric motor, powered either by mechanical torque to provide electricity, or by electricity to provide torque.

Advantageously, the electric current produced by the electric machine 23 is a three-phase alternating current. The electric machine 23 is, for example, of the synchronous, asynchronous, or even, variable reluctance type.

The electric machine 23 comprises a winding 25. The winding 25 comprises three coils 26, 27, and 28 to produce three-phase alternating current. In one alternative, not represented, the winding 25 comprises more than three coils. The coils 26, 27, and 28 are, for example, formed by coils, and connected in a star configuration. Thus, the winding 25 comprises a midpoint 29, also called a neutral point, common to each coil 26, 27, 28.

The network 20 further comprises a converter 30, connected to the coils 26, 27, and 28. Advantageously, the converter 30 comprises an input 31, an output 32, and three branches 36, 37, and 38 connected in parallel to each other on the output 32. Each branch comprises two switches, respectively switches 41, 42; 43, 44, and 45, 46. By switch, we mean a component that can be controlled in switching. Each branch 36, 37, 38 comprises two diodes, respectively 51, 52; 53, 54, and 55, 56. In the example of FIG. 1, each diode 51 to 56 is associated with a respective switch 41 to 46 and is arranged in parallel with the switch to which it is associated. The switches 41 to 46 are advantageously semiconductor switches, such as field-effect transistors, or FETs, from the English “Field Effect Transistor,” insulated gate bipolar transistors, or IGBTs, from the English “Insulated Gate Bipolar Transistor.”

In one alternative, not represented, each branch comprises more than two switches and more than two diodes.

Each branch 36, 37, 38 comprises a midpoint, respectively 61, 62, 63, located between the two switches of the branch 41, 42; 43, 44, and 45, 46. The midpoints 61, 62, 63 are connected to one of the coils of the machine 23, respectively 26, 27, and 28 and form the input 31.

The converter 30 also comprises a capacitor 66, connected in parallel with the branches 36, 37, 38.

The network 20 further comprises an electronic control unit 68 for the converter 30, connected to the converter 30. The electronic control unit 68 is, for example, implemented as a programmable logic component, such as an FPGA, from the English “Field Programmable Gate Array,” or an integrated circuit, such as an ASIC, from the English “Application Specific Integrated Circuit.”

The electronic control unit 68 is configured to control the converter 30 in a voltage rectifier operation (AC/DC) and in a voltage step-up operation (DC/DC), as explained in more detail below. Advantageously, the electronic control unit is also configured to control the converter 30 in an inverter operation (DC/AC). For this, the electronic control unit 68 controls each switch 41 to 46 between a closed configuration and an open configuration, as known per se.

The output 32 of the converter 30 is connected to the loads of the aircraft 10. The loads are, for example, the loads 69 of the aircraft onboard network, a battery 70, or a secondary power unit. The loads 69 of the onboard network comprise electronic components necessary for the operation of the aircraft 10. The battery 70 is optional. The battery 70 is advantageously a high-voltage battery, delivering, for example, a voltage greater than 250V, for example, equal to 270V. According to an example, and as represented in FIG. 1, the battery 70 is constituted of a plurality of batteries, connected, for example, in parallel on a battery bus. The battery 70 advantageously serves to power the loads 69 of the aircraft onboard network. Advantageously, the battery 70 also serves to start or electrically assist the engine 21.

In the example of FIG. 1, a positive terminal of the output 32 of the converter 30 is connected to an interconnection bus 72 and a positive terminal of the battery 70 is connected to a sharing bus 74, respectively by means of the switches 76 and 77. The interconnection bus 72 and the sharing bus 74 are connected to each other by means of a sharing switch 78. A negative terminal of the output 32 of the converter 30 is directly connected to the battery 70, in particular to a negative terminal of the battery 70. Alternatively, the second terminal of the output 32 and the negative terminal of the battery 70 are both connected to a common reference potential.

Advantageously, the loads 69 of the onboard network are connected to the interconnection bus 72.

The network 20 further comprises means 80 of connecting the neutral point 29 to an external power source, which is here a ground power unit 82. The connections 80 are, for example, formed by connection buses to connect a positive terminal of the ground power unit 82 to the neutral point 29 on the one hand, and to connect a negative terminal of the ground power unit 82 to the branches 36, 37, and 38 of the converter 30. Alternatively, the negative terminal of the ground power unit 82 is connected to the reference potential, or directly to a negative terminal of the battery 70. Advantageously, the connections 80 further comprises a switch 83, which, when in a closed configuration, allows an electric current to flow from the ground power unit 82 toward the neutral point 29.

The ground power unit 82 is also known by its English name “Ground Power Unit,” or GPU. The ground power unit 82 is configured to provide a direct current. According to one example, the direct current provided by the ground power unit 82 is a low-voltage direct current, for example, with a voltage less than 30V, preferably equal to 28V.

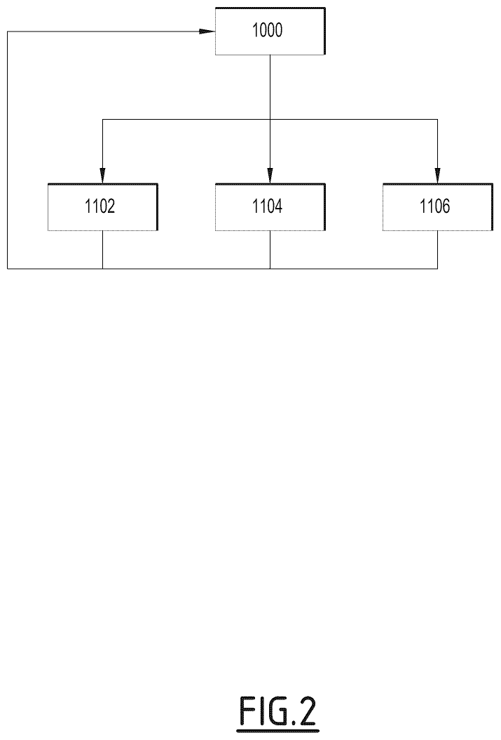

A control method for the power supply network 20 is now described with reference to FIG. 2. The method is implemented by the electronic control unit 68.

The electronic control unit 68 is advantageously in an initial state 1000.

In the absence of a ground power unit 82, when the electric machine 23 converts a mechanical torque, provided by the engine 21 into an alternating electric current, the electronic control unit 68 controls the converter 30 in the voltage rectifier operation mode during a step 1102. The step 1102 is, for example, carried out when the aircraft 10 is in flight. The direct current produced by the converter 30 is used, for example, to power the loads, for example, to power the loads 69 and/or charge the battery 70.

When the connections 80 is connected to the ground power unit 82 for powering the neutral point 29, and advantageously, the switch 83 is in a closed configuration, the electronic control unit 68 controls the converter 30 in the voltage step-up operation during a step 1104. In this case, the coils 26, 27, and 28 and the converter 30 work together as a voltage step-up converter. The step 1104 takes place when the aircraft 10 is on the ground, in order to be able to connect the connections 80 to the ground power unit 82.

The ground power unit 82 provides, for example, a direct current with a voltage equal to 28V, and the assembly formed by the coils 26, 27, and 28, as well as the converter 30, controlled by the electronic control unit 68, convert the current into high-voltage direct current, for example, greater than 250V, in order to electrically power the aircraft 10. This consists of powering the loads, for example, the loads 69, and/or charging the battery 70. Once charged, the battery 70 is used, for example, to power the loads 69, or electrically assist the engine 21, for example, when the aircraft 10 is in flight.

The winding 25 is thus used with the converter 30 to convert the direct current into high voltage, which allows the use of already existing and integrated elements in the network 20 to electrically power the aircraft 10, for example, to charge the battery 70 using the ground power unit 82. It is therefore not necessary to provide an additional winding and/or converter to electrically power the aircraft 10 from the ground power unit 82.

Advantageously, the electronic unit 68 controls the converter 30 in the inverter operation in order to electrically power the electric machine 23 from the battery 70 during a step 1106. In this case, the electric machine 23 generates a mechanical torque from the electric current provided by the inverter 30 in order to operate the engine 21. The step 1106 is, for example, carried out on user command, who wishes, for example, that the engine 21 be powered by electricity for its operation. This allows, for example, to start the engine 21, or to assist it in case of failure.

Advantageously, the electronic unit 68 transitions from one of the steps 1102, 1104, or 1106 and returns to the initial state 1000, for example, once a predetermined duration has elapsed, or following a user command.

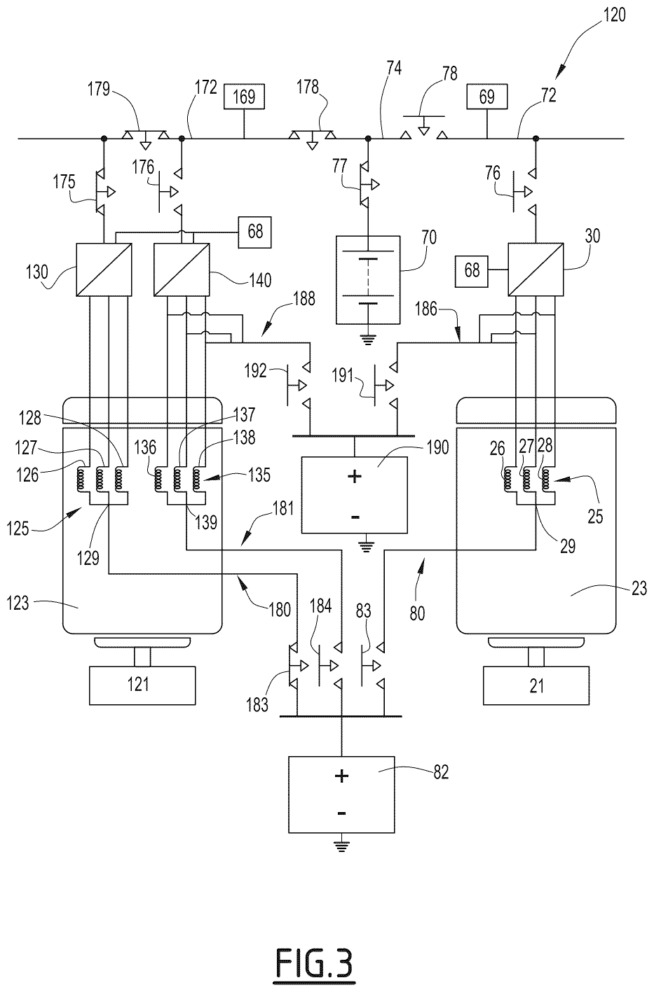

FIG. 3 is a diagram of a network 120, as an alternative embodiment to the network 20. The network 120 comprises the elements included in the network 20, and further comprises a drive engine 121, also simply called engine, and an electric machine 123. The aircraft 10, comprising two engines 21 and 121, is said to be twin-engine. The engine 121 is identical to the engine 21.

The electric machine 123 is similar to the electric machine 23 except for the differences described below. The electric machine 123 comprises a winding 125, each comprising three coils connected in a star configuration, respectively the coils 126, 127, and 128 for the winding 125. The winding 125 thus comprises a midpoint, or neutral point 129. The network 120 comprises a converter 130, functionally similar to the converter 30. The converter 130 is connected to the coils 126, 127, and 128.

In addition, the electric machine 123 comprises a winding 135, comprising coils 136, 137, and 138, connected in a star configuration at a neutral point 139. The network 120 also comprises a converter 140, connected to the coils 136, 137, and 138.

The electronic control unit 68 is also connected to the converters 130 and 140 and is configured to control each of the converters 30, 130, and 140 in a voltage rectifier operation and in a voltage step-up operation.

The converters 130 and 140 are connected in output to the loads, being connected to an interconnection bus 172, respectively by means of the switches 175 and 176. More specifically, a positive output terminal of the converters 130 and 140 is connected to the loads via the interconnection bus 172. The loads comprise the battery 70, connected to the interconnection bus via the sharing bus 74, the loads 69 of the onboard network, and in addition, advantageously comprise the additional loads 169, connected to the interconnection bus 172. Alternatively, the loads 169 belong to an additional onboard network.

The interconnection bus 172 is connected to the sharing bus 74, and therefore to the battery 70 by means of a sharing switch 178. The interconnection bus 172 comprises an interconnection switch 179, allowing to electrically isolate the converters 130 and 140 from each other. The sharing switches 78 and 178 allow to isolate the sharing bus 74 from the interconnection buses 72 and 172 respectively, for example, in case of electrical fault on one of the interconnection buses 72 and 172.

A negative output terminal of the converters 130 and 140, not represented, is connected to the negative terminal of the battery 70, or alternatively, to the ground.

The network 120 further comprises connections 180 and 181 of the neutral points 129 and 139 to the ground power unit 82. The connections 180 and 181 are, for example, formed of connection buses to connect a positive terminal of the ground power unit 82 to the neutral point 129, to connect the positive terminal of the ground power unit 82 to the neutral point 139, and to connect the converters 130 and 140 to the negative terminal of the ground power unit 82, the latter not being represented.

The connections 180 and 181 respectively comprise switches 183 and 184, which, when in a closed configuration, allow an electric current to flow from the ground power unit 82 toward respectively the neutral point 129 and the neutral point 139, in the respective converters 130 and 140 and to the negative terminal of the ground power unit 82.

Advantageously, the network 120 further comprises auxiliary connections 186 and 188 of the converters 30 and 140 to an additional external power source 190. The additional external power source 190 is advantageously present on the ground and is not part of the network 120. The additional external power source 190 is configured to provide an alternating current, for example, with an effective voltage equal to 115V.

The auxiliary connections 186 and 188 are, for example, cables or connection buses. The auxiliary connections 186 and 188 respectively comprise switches 191, 192, which, when in a closed configuration, connect respectively a positive terminal of the additional external power source 190 via 186 and 188 to the input of the converters 30 and 140.

In one alternative, not represented, the auxiliary connections 186 is configured to further connect the converter 130 and the external power source 190.

The control method for the power supply network 120 is similar to that of the power supply network 20 except for the differences described below. During the step 1102, the electronic control unit 68 controls each converter 30, 130, and 140 in the voltage rectifier operation, when the electric machines 23 and 123 convert a mechanical torque, provided respectively by the engines 21 and 121, into an alternating voltage.

Advantageously, the switches 76, 77, 78, and 175, 176, 178, and 179 are controlled in a closed or open configuration, depending on the needs of a user, for example, who wishes to power the loads 69 and 169, connected to the interconnection buses 72 and 172, without charging the battery 70.

According to one example, not represented, during the step 1102, the switches 77 and 179 are in an open configuration, to not charge the battery 70, and to avoid a short circuit between the converters 130 and 140.

According to another example, not represented, the battery 70 is charged from the engine 121, the switches 77, 175, 178, and 179 being in a closed configuration, and the other switches in an open configuration.

Alternatively, one of the engines, for example, the engine 121 is used to charge the battery 70, and the other engine, for example, the engine 21 is used to power the loads 69.

Advantageously, the step 1102 is also carried out when the auxiliary connections 186 and/or 188 are connected to the external power source 190. In other words, when the auxiliary connections 186 and/or 188 are connected to the external power source 190, the electronic control unit 68 controls the converter 30 and/or the converter 140 in the voltage rectifier operation, for powering the converter 30 and/or the converter 140 in order to power the loads, for example, to power the loads of the onboard networks 69 and/or 169, or, alternatively or in addition, to charge the battery 70.

During step 1104, the electronic control unit 68 controls at least one of the converters 30, 130, and 140 in the voltage step-up operation when the corresponding connection is connected to the ground power unit 82.

In the example of FIG. 3, the connections 180 is connected to the ground power unit 82, and the switch 183 is in a closed configuration. Thus, only the neutral point 129 is connected to the ground power unit 82 for its power supply. The converter 130 is then controlled in the voltage step-up operation by the electronic control unit 68 in order to electrically power the loads 69 and 169 and/or charge the battery 70.

Advantageously, during the step 1104, the switches 77, 175, 178, and 179 are also in a closed configuration, in order to allow the current to flow from the converter 130 to the battery 70, and the other switches are in an open configuration.

Alternatively, during step 1104, the electronic control unit 68 controls each converter 30, 130, and 140 in the voltage step-up operation, when the connections 80 and 180 are connected to the ground power unit 82 for powering the neutral points 29, 129, and 139. The switches 83, 183, and 184 are closed to ensure the connection of the connections 80, 180, and 181 to the ground power unit 82. The voltage provided by the ground power unit 82 via the connections 80, 180, and 181 flows in the neutral point 29, in the neutral point 129, and in the neutral point 139 at the same time. In other words, all the converters 30, 130, and 140 are powered simultaneously by the ground power unit 82. The switches 76, 77, 78, 175, 176, 178, and 179 are in a closed configuration to ensure the electrical power supply of the loads, for example, the charging of the battery 70. Alternatively, the switches 76, 77, 175, 176, 178, and 179 are in a closed configuration and the switch 78 is in an open configuration. In this case, the converters 130 and 140 power the battery 70 and the loads 169, and the converter 30 powers other loads of the aircraft 10, such as, for example, the loads 69.

In another alternative, the switches 83, 183, and 184 are controlled by a user so that the converters 30, 130, and 140 are powered cyclically. For example, when the switch 83 is in a closed configuration, the switches 183 and 184 are in an open configuration. Only the neutral point 29 is powered, and only the converter 30 is controlled in the voltage step-up operation. After a predetermined duration, or alternatively, when a temperature in the winding 25 exceeds a threshold, the switch 83 switches to an open configuration and the switch 183 switches to a closed configuration, the converter 130 is controlled in the voltage step-up operation and the converter 30 is no longer controlled in the voltage step-up operation. Similarly, after a predetermined duration, or when a temperature of the winding 125 exceeds a threshold, the switch 183 switches to an open configuration, the switch 184 switches to a closed configuration, the converter 140 is controlled in the voltage step-up operation and the converter 130 is no longer controlled in the voltage step-up operation. The battery 70 is thus powered successively by the converters 30, 130, and 140.

Other alternatives are still possible, such as powering the loads 69 and 169 by the converter 30 by switching the switches 76, 78, and 178 to a closed configuration, the other switches being in an open configuration.

Advantageously, during the step 1106, at least one of the converters 30, 130, and 140 is controlled in the inverter operation. In this case, the electric machine 23 or 123 connected to the converter 30, 130, or 140 controlled in the inverter operation drives the engine 21 or 121 to which it is connected.

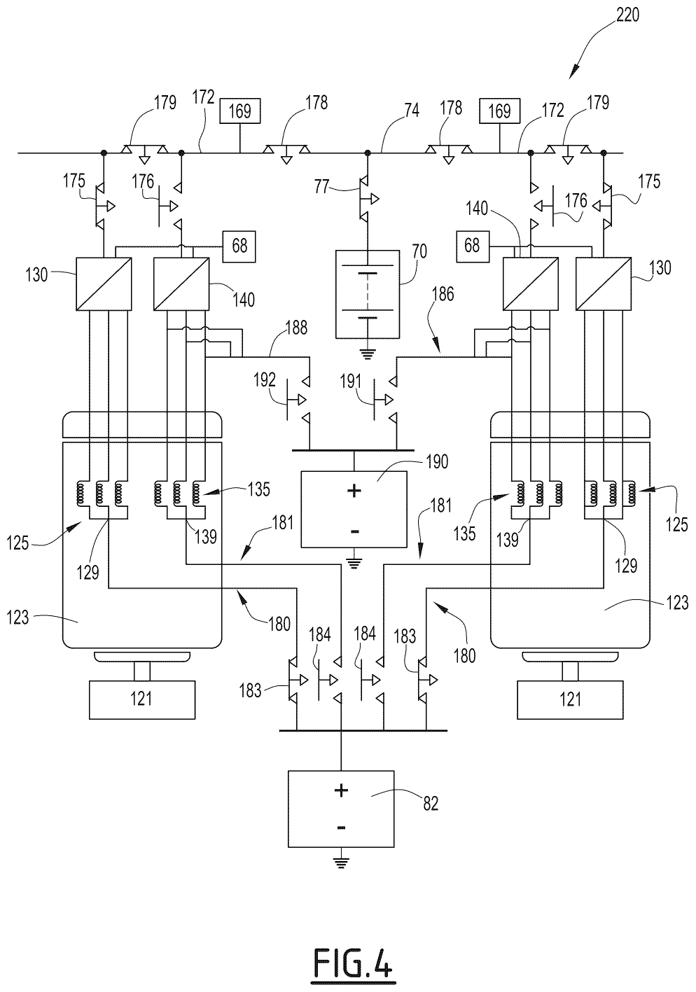

FIG. 4 represents a diagram of a network 220, as an alternative embodiment to the network 120. The network 220 is similar to the network 120, except for the differences described below. The network 220 comprises two drive engines 121. The electric machine 123, the converters 130 and 140, as well as the connections 180 and 181, replace respectively the electric machine 23, the converter 30, as well as the connections 80. Similarly, an interconnection bus 172 replaces the interconnection bus 72 and the switches 175, 176, on the one hand, and 178 and 179 on the other hand replace the switches 76 and 78. The loads 169 are each connected to one of the interconnection buses 172. The auxiliary connections 186 is configured to connect the converter 140 and the external power source 190.

The electronic control unit 68 is connected to each converter 130 and 140, and configured to control each converter 130, 140 according to the voltage rectifier operation when the electric machines 123 convert a mechanical torque provided by the engines 121 into an alternating electric current, and advantageously, when the connections 186, 188 are connected to the external power source 190. The electronic control unit 68 is also configured to control each converter 130, 140 according to the voltage step-up operation when the connections 180, 181 are connected to the ground power unit 82 for powering the midpoints 129, 139, in order to electrically power the loads, for example, power the loads of the onboard network 169 and/or charge the battery 70.

The control method for the network 220 is identical to that which has been described for the network 120.

In the example of FIG. 4, the connections 180 and 181 are connected to the ground power unit 82 because the switches 183 are in a closed configuration. The converters 130 are controlled in the voltage step-up operation by the electronic control unit 68. The switches 175, 178, and 179 are in a closed configuration and the other switches are in an open configuration. Thus, the battery 70 is powered simultaneously by the converters 130. In an alternative, not represented, one of the switches 178 is in an open configuration. In this case, the two converters 130 and 140, connected to the same electric machine 123, power the battery 70 and a part of the loads 169 and the two other converters 130 and 140 power the other loads of the aircraft 10, such as, for example, the other part of the loads 169.

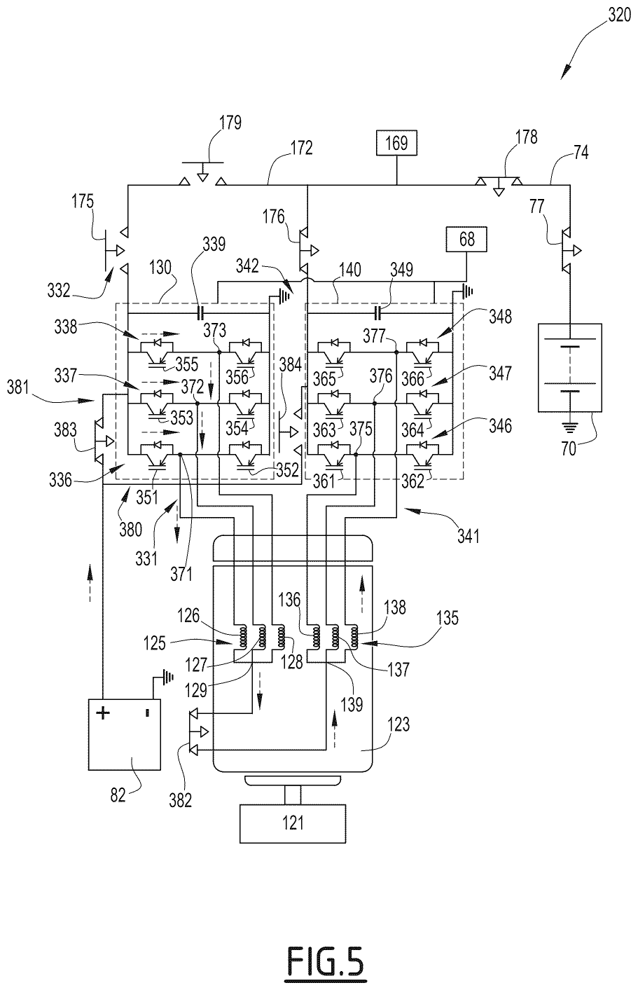

FIG. 5 represents a network 320, as an alternative embodiment to the networks 20, 120, and 220 described previously. The elements identical to those of the previous embodiments are designated by the same reference signs, and mainly what distinguishes this embodiment from the other embodiments is described.

The network 320 represented in FIG. 5 comprises only one engine 121. In an alternative, not represented, the network 320 comprises two engines, in a similar manner to the networks 120 and 220.

The converters 130 and 140 each comprise an input 331 and 341, an output 332 and 342, three branches, respectively 336, 337, and 338, and 346, 347, and 348, and a capacitor, respectively 339 and 349 connected in parallel with the branches 336, 337, and 338 on the one hand and 346, 347, and 348 on the other hand.

Each branch comprises two switches, respectively 351, 352, 353, 354, 355, and 356 for the converter 130 and 361, 362, 363, 364, 365, and 366 for the converter 140, and two diodes, one diode being associated with a switch and in parallel with it. Each branch 336, 337, and 338 comprises a midpoint, respectively 371, 372, and 373, connected respectively to the coils 126, 127, and 128, and each branch 346, 347, and 348 comprises a midpoint, respectively 375, 376, and 377, connected respectively to the coils 136, 137, and 138.

A positive terminal of the outputs 332 and 342 is connected to the interconnection bus 172, and a negative terminal of the outputs 332 and 342 is connected to a reference potential.

The network 320 comprises connections 380 and 381 of the neutral points 129 and 139 to the ground power unit 82. The connections 380 and 381 are, for example, formed of connection buses, and the switches 361, 363, and 365 on the one hand, and 351, 353, and 353 on the other hand, to connect the positive terminal of the ground power unit 82 to the neutral points 129 and 139, respectively. Thus, as visible in FIG. 5, the connections 381 connects the positive terminal of the ground power unit 82 to the positive terminal of the output 332 of the converter 130. The neutral point 129 is thus powered by means of the converter 130 when the switches 351, 353, and 355 are all configured or alternatively in a closed configuration.

Advantageously, the network 320 further comprises a switch 382, between the neutral points 129 and 139. The switch 382 is external to the electric machine 123. When the switch 382 is in a closed configuration, it connects the midpoints 129 and 139 to each other.

The second neutral point 139 is thus powered from the converter 130 when the switch 382 is in a closed configuration.

Similarly, the connections 380 connects the positive terminal of the ground power unit 82 to the positive terminal of the output 342 of the converter 140, to power the neutral point 139 via the transistors 361, 363, 365. The neutral point 129 is powered when the switch 382 is in a closed configuration.

The connections 380 and 381 advantageously comprise respectively the switches 383 and 384, which, when they are in a closed configuration, allow an electric current to flow from the ground power unit 82 toward respectively the converter 130, and the converter 140.

In the example of FIG. 5, during the steps 1102 and 1106, the switch 382 is in an open configuration.

During the step 1104, the converter 140 is controlled in the voltage step-up operation by the electronic control unit 68 when the connections 381 is connected to the ground power unit 82 and when the neutral points 129 and 139 are connected to each other, by the switch 382 which is controlled in a closed configuration. The converter 130 is controlled by the electronic control unit 68 to act as three wires, notably, for each branch 336, 337, and 338 of the converter 130, one of the switches is controlled in a closed configuration and the other switch is controlled in an open configuration. The switches 351, 353, and 355 are controlled in a closed configuration and the switches 352, 354, and 356 are configured in an open configuration.

Furthermore, the switches 77, 176, and 178 are in a closed configuration and the switches 175 and 179 are in an open configuration. Thus, the voltage delivered by the ground power unit 82 flows in the connections 381, in the winding 125 to the neutral point 139, through the winding 135 and the converter 140 which steps up the voltage, then through the interconnection bus 172 and the sharing bus to charge the battery 70, as indicated by the dotted arrows.

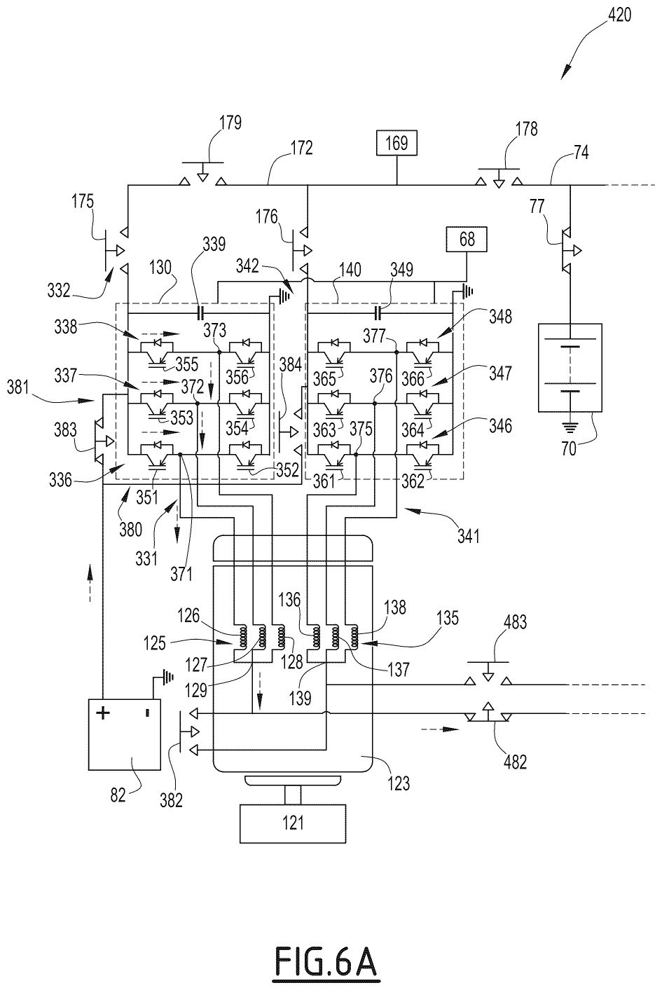

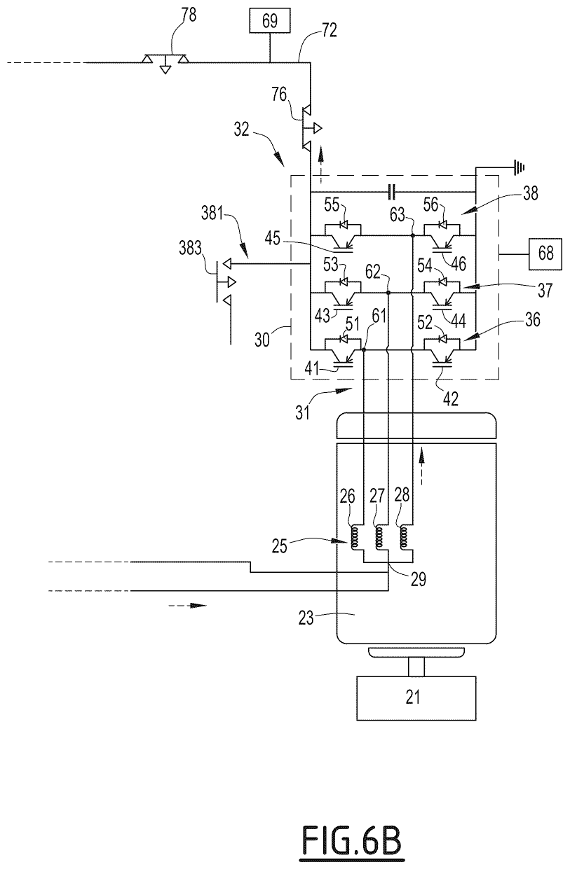

FIGS. 6A and 6B represent a network 420, similar to the network 320 except for the following differences. The network 420 comprises an engine 21 in addition to the engine 121, which comprises a coil 25 and the windings of which are connected respectively to a converter 30. The converter 30 is connected at its output 32 to the loads of the aircraft 10, for example, the loads 69, the battery 70, as that already described in the context of FIG. 3.

The network 420 comprises another connections 381 of the neutral point 29 to the ground power unit 82. In FIG. 6, more precisely on FIG. 6B, the connection of this other connections 381 to the ground power unit 82 is not represented. This other connections 381 is, for example, formed of the connection bus and the switches 41, 43, and 45 to connect the positive terminal of the ground power unit 82 to the neutral point 29. The neutral point 29 is thus powered by means of the converter 30 when the switches 41, 43, 45 are all or alternatively in a closed configuration.

The network 420 further comprises a switch 482, between the neutral points 29 and 129, and, advantageously, a switch 483 between the neutral points 29 and 139. The switches 482 and 483 are external to the electric machines 23 and 123. When the switch 482 is in a closed configuration, it connects the midpoints 29 and 129 to each other. When the switch 483 is in a closed configuration, it connects the midpoints 29 and 139 to each other.

In the example of FIGS. 6A and 6B, the switch 383 connecting the power unit 82 and the converter 130, and the switch 482 are in a closed configuration. During the step 1104, the converter 30 is controlled in the voltage step-up operation by the electronic control unit 68 when the connections 381 is connected between the converter 130 and the ground power unit 82 and when the neutral points 129 and 29 are connected to each other by the switch 482 which is controlled in a closed configuration. The converter 130 is configured to act as three wires.

In addition, the switches 76, 77, and 78 are in a closed configuration and the switches 175, 176, and 179 are in an open configuration. The switches 382 and 483 are also in an open configuration. Thus, the voltage delivered by the ground power unit 82 flows in the connections 381, in the winding 125, through the switch 482 to the neutral point 29, through the winding 25 and the converter 30 which steps up the voltage, then through the interconnection bus 72 and the sharing bus 74 to charge the battery 70, as indicated by the dotted arrows.

The operation is similar if the ground power unit 82 is connected to the converter 30 via the connections 381, to power one of the converters 130 or 140 respectively via the neutral points 129 and 139, by closing the switches 482, 483 respectively. The converter 30 is then controlled to act as three wires and the converter 130 or 140 respectively, is controlled in the voltage step-up operation. The operation is also similar if the ground power unit 82 is connected to the converter 140 to power the neutral point 29 and the converter 30. In this case, the connections 380 connects the converter 140 and the ground power unit 82, the switch 384 being closed. The switch 483 is closed, the converter 140 is controlled to act as three wires, and the converter 30 is controlled in the voltage step-up operation.

One alternative, not represented, is a network comprising two engines, but each engine comprises only one coil, these two coils can be connected to each other via a switch 482, in a similar manner to that which has been described for the network 420. Another alternative, is a network comprising two engines each comprising two coils, and the neutral points of the coils of one of the engines can be connected to each other as described for the network 320, or to one or the other of the neutral points of the coils of the other engine, in a similar manner to that which has been described for the network 420, by duplicating the switches 482 and 483.

In one alternative, not represented, the network comprises more than two drive engines and several electric machines, mechanically connected to one of the drive engines. In another alternative, each electric machine may comprise more than two coils, each being connected to a converter itself connected to the interconnection bus 72 or 172.

Any feature described for one embodiment or an alternative, in the above can be implemented for the other embodiments and alternatives, described previously, as long as technically feasible.

In particular, according to one alternative, not represented, the network 120 comprises a switch 382 connected between the midpoints 129 and 139. Alternatively, or in addition, the network 120 comprises a switch 482 connecting the midpoints 129 and 29 and/or a switch 483 connecting the midpoints 139 and 29.

The network 120 then also comprises connections 380, which connect the positive output terminal of the converter 140 to the ground power unit 82, and connections 381 which connect the positive output terminal of one of the converters 130 or 30 to the ground power unit 82, depending on the converter 30, 130, or 140 which is used as three wires.

According to one alternative, the network 220 comprises one or two switches 382, connected, if applicable, respectively between the midpoints 129 and 139 of the same electric machine. Alternatively, or in addition, the network 220 comprises one or two switches 482, connecting respectively the two midpoints 129 to each other, and two midpoints 129 and 139 of different electric machines to each other. Alternatively, or in addition, the network 220 comprises one or two switches 483, connecting respectively the two midpoints 139 to each other, and the two other midpoints 129 and 139 to each other.

The network 220 then also comprises connections 380, which then connect the positive output terminal of one of the converters 140 to the ground power unit 82, and the connections 381 which connects the positive output terminal of one of the converters 130 to the ground power unit 82, depending on the converter 130 or 140 which is used as three wires.

What is claimed is:

1. A power supply network for an aircraft, the power supply network comprising:
a drive engine;
an electric machine mechanically connected to the drive engine for driving the electric machine, the electric machine comprising at least one winding, the or each winding comprising at least three coils connected to each other in a star configuration, the or each winding comprising a common midpoint for each coil;
at least one converter connected to the coils of the or of one of the windings of the electric machine;
loads connected to the or each converter;
an electronic control unit for the or each converter, the electronic control unit being configured to control at least one converter from among the converters in a voltage rectifier operation when the electric machine converts a mechanical torque provided by the drive engine into an alternating electric current; and
at least one connection of the common midpoint of the or each winding to a ground power unit,
the electronic control unit being configured to control at least one converter from among the converter(s) in a voltage step-up operation when the at least one connection is connected to a ground power unit for powering the midpoint of the or each winding, in order to electrically power the loads.

2. The network according to claim 1, wherein the at least one winding comprises a first and a second winding, and the at least one converter comprises a first converter and a second converter, the first converter being connected to the coils of the first winding and the second converter being connected to the coils of the second winding.

3. The network according to claim 1, wherein the at least one winding comprises a first winding and a second winding, and the second winding comprises at least three coils connected to each other in a star configuration and a common midpoint for each coil,
the at least one converter comprising a first and a second converter, the first converter being connected to the coils of the first winding and the second converter being connected to the coils of the second winding, and
the network further comprising a switch, connected between the common midpoints of the first and second windings and wherein, when the second converter is controlled in a voltage step-up operation, the common midpoints of the first and second windings are connected to each other by the switch, and the at least one connection connects a positive output terminal of the first converter to the ground power unit to power the midpoint of the second winding by means of the first converter and the first winding, in order to electrically power the loads.

4. The network according to claim 1, the network further comprising:
a second drive engine;
a second electric machine mechanically connected to the second drive engine for driving the second electric machine, the second electric machine comprising a winding comprising at least three coils, connected to each other in a star configuration, so that the winding comprises a common midpoint for each coil;
a third converter, connected to the coils of the second electric machine and to the loads;
the at least one connection is a first connection and a second connection of the common midpoint of each winding of the first electric machine to the ground power unit and the network comprises a third connection of the midpoint of the winding of the second electric machine to the ground power unit;
the electronic control unit being configured to control the third converter in a voltage rectifier operation when the electric machine converts a mechanical torque provided by the second drive engine into an alternating electric current, and to control the third converter in a voltage step-up operation when the second connection is connected to the ground power unit for powering the midpoint of the winding of the second electric machine in order to electrically power the loads.

5. The network according to claim 1, wherein the or each winding comprises three coils and the or each converter comprises three branches, each branch comprising two switches, and a midpoint of each branch, located between the two switches being connected to a coil of the winding.

6. The network according to claim 1, wherein the network comprises at least one auxiliary connection of the or each converter to an external power source, and the electronic control unit is further configured to control the or each converter according to the voltage rectifier operation also when the at least one auxiliary connection is connected to an auxiliary ground power unit, the at least one auxiliary connection each comprising a switch, for powering the or each converter in order to electrically power the loads.

7. The network according to claim 1, wherein the loads include a battery, with a voltage greater than or equal to 250V, connected to the or each converter, and when the electronic control unit controls at least one converter from among the converters in a voltage step-up operation, the battery is electrically powered in order to be charged.

8. An aircraft comprising a power supply network according to claim 1.

9. A control method for a power supply network according to claim 1, implemented by the electronic control unit, the method comprising the following steps:
controlling at least one from among the converters in a voltage rectifier operation, when the electric machine converts a mechanical torque provided by the drive engine into alternating electric current; and
controlling at least one converter from among the converters in a voltage step-up operation when at least one of the at least one connection is connected to the ground power unit for powering the midpoint of the winding.

10. The control method according to claim 9 wherein the method further comprises controlling at least one converter from among the converters in an inverter operation in order to electrically power the electric machine from a battery connected to the or each converter.

11. The control method according to claim 9 wherein the network comprises at least one auxiliary connection of the or each converter to an external power source, and the step of controlling the converter in the voltage rectifier operation is also carried out when the at least one auxiliary connection is connected to an auxiliary ground power unit.
